(19) United States
(12) Patent Application Publication
(10) Pub. No.: US 2025/0001925 A1
(43) Pub. Date: Jan. 2, 2025

(54) ACCESSORY MOUNT

(71) Applicant: Rivian IP Holdings, LLC, Irvine, CA (US)

(72) Inventors: Fong Shyr YANG, Irvine, CA (US); Nathan HERONEN, San Juan Capistrano, CA (US)

(21) Appl. No.: 18/344,775

(22) Filed: Jun. 29, 2023

(51) Int. Cl. B60P 7/08; B60Q 1/44; B60R 16/03; B62D 33/027

(52) U.S. Cl. CPC B60P 7/08; B60Q 1/44; B60R 16/03; B62D 33/0273

(57) ABSTRACT

An accessory mount for a vehicle includes a support configured to interface with an inner surface of a gate of a vehicle. The support is further configured to support an accessory. A mounting structure is mounted to the support and configured to mount to at least one of the accessory or a crossbar to which the accessory is mounted.

### INTRODUCTION

The present disclosure relates to mounting accessories to vehicles.

### SUMMARY

The present disclosure describes an accessory mount for supporting accessories mounted to the vehicle and extending out over a gate of the vehicle.

In one or more embodiments, an apparatus includes a support configured to interface with an inner surface of a gate of a vehicle, the support being further configured to support an accessory. A mounting structure is mounted to the support and configured to mount to at least one of the accessory or a crossbar to which the accessory is mounted.

In one or more embodiments, a method includes pivoting a gate of a vehicle away from a cargo floor of the vehicle. A support is positioned on an upper surface of the gate. An accessory is mounted to the support and to sidewalls of the vehicle on either side of the cargo floor such that at least a portion of a weight of the accessory is transmitted to the sidewalls and to the gate through the support.

### BRIEF DESCRIPTION OF THE DRAWINGS

FIG. 1A illustrates a vehicle with a first embodiment of an accessory mount positioned on the gate thereof and supporting an accessory, in accordance with certain embodiments.

FIG. 1B illustrates a vehicle with a second embodiment of an accessory mount positioned on the gate thereof and supporting an accessory, in accordance with certain embodiments.

FIG. 1C illustrates a vehicle with a third embodiment of an accessory mount positioned on the gate thereof and supporting an accessory, in accordance with certain embodiments.

FIG. 2A illustrates an accessory mount with a hinged crosspiece, in accordance with certain embodiments.

FIG. 2B illustrates accessibility to a truck bed with an accessory mount present, in accordance with certain embodiments.

FIG. 3A illustrates a port for coupling a brake light of an accessory mount to a vehicle, in accordance with certain embodiments.

FIG. 3B illustrates an accessory mount coupled to the port, in accordance with certain embodiments.

FIGS. 4A to 4C illustrate example crossbars for use with an accessory mount, in accordance with certain embodiments.

FIG. 4D illustrates an example mounting structure for an accessory mount, in accordance with certain embodiments.

FIG. 5 is a process flow diagram of a method for using an accessory mount, in accordance with certain embodiments.

### DETAILED DESCRIPTION

Off-road vehicles enable a driver and passengers to explore exciting new locations. A vehicle may be provided with accessories, such as a roof-top or truck-bed tent, a camp kitchen, and the like to make overnight camping more comfortable. In prior approaches, an accessory that is too large to mount in or over the bed of a truck may be mounted to a rack mounted over the bed, with the accessory extending over the roof of the cab of the truck. This has the disadvantage of placing the accessory at an inconvenient height and drastically increasing the aerodynamic drag of the truck.

The present disclosure provides an accessory mount that can be supported by a gate of a vehicle that is at least partially opened such that an accessory may extend beyond the cargo bed of the vehicle. An accessory may be mounted directly to the accessory mount, or the accessory may mount to a crossbar that is coupled to the accessory mount. The accessory mount may rest on the gate or may fasten to the gate. In some embodiments, the accessory mount may include two supports with one or more crosspieces, which may be hinged to facilitate access to a cargo area. The accessory mount may incorporate a brake light to compensate for a brake light of the vehicle being obscured by an accessory. The accessory mount disclosed herein thereby can provide the advantage of positioning an accessory lower than prior approaches, and possibly below a roofline of the vehicle, which reduces the aerodynamic penalty imposed by the accessory.

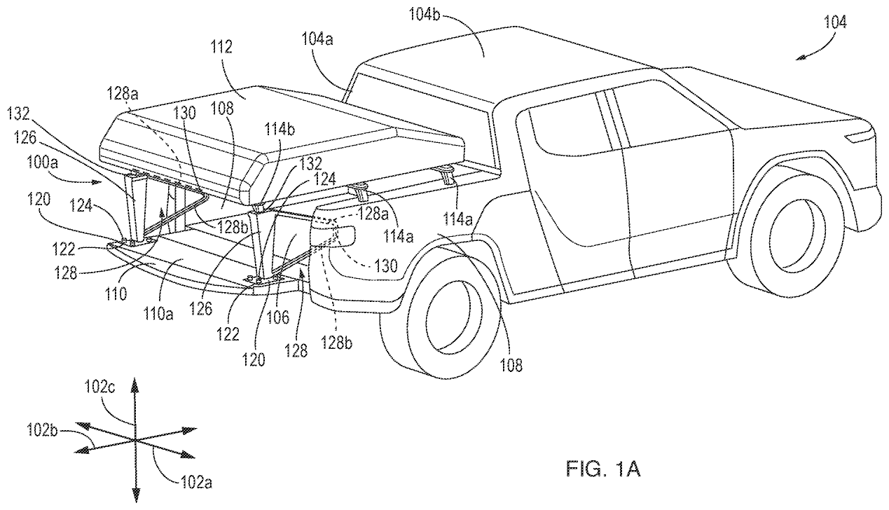

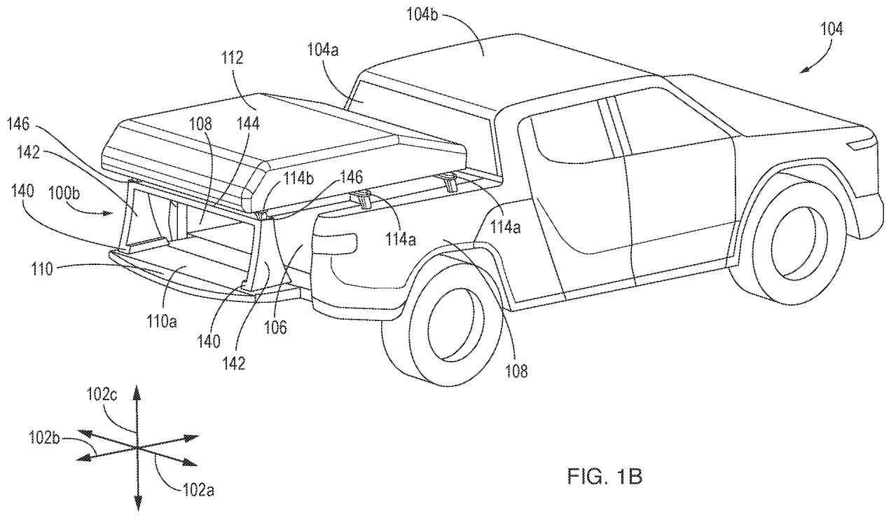

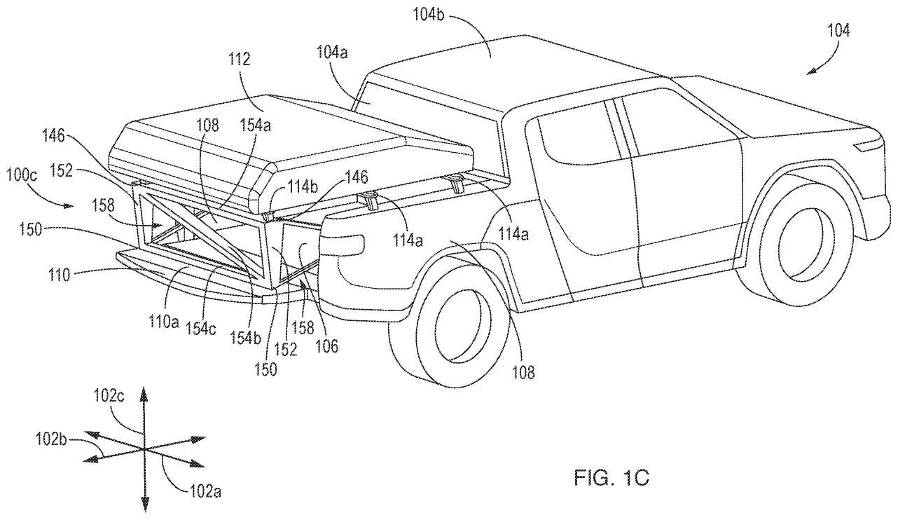

Referring to FIGS. 1A, 1B, and 1C, accessory mounts 100a, 100b, 100c described below may be understood with respect to a horizontal direction 102a, a longitudinal direction 102b, and a vertical direction 102c, that are all perpendicular to one another. The accessory mounts 100a, 100b, 100c are described with respect to the directions 102a, 102b, 102c to facilitate understanding of the relative positions and orientations of components of the accessory mounts 100a, 100b, 100c with the understanding that the directions 102a, 102b, 102c need not correspond to the actual orientation of the accessory mount 100a. 100b, 100c during use. In the illustrated example, the vertical direction 102c corresponds to the direction of gravity when a vehicle 104 used in combination with the accessory mount 100a, 100b, 100c is resting on a flat surface, and the longitudinal direction 102b corresponds to the direction of travel of the vehicle when traveling forward in a straight line (hereinafter referred to as simply “the direction of travel”). In other methods of use, the orientations of the directions 102a, 102b, 102c may have a different relationship relative to the direction of travel and direction of gravity of the vehicle 104. The vehicle 104 may be embodied as a pick-up truck including a cab 104a having a roof 104b. As discussed in greater detail below, the accessory mount 100a, 100b, 100c facilitates mounting of an accessory with no, or reduced, extension above the roof 104b along the direction of gravity with the vehicle 104 supported on a flat surface.

In the illustrated example, the vehicle 104 includes a cargo floor 106, such as the bed of a pickup truck or floor of a front trunk (frunk). The vehicle 104 includes sidewalls 108 positioned on either side of the cargo floor 106 and extending vertically upward from the sidewalls 108, such as substantially (e.g., within 10 degrees of) parallel to the longitudinal direction 102b and vertical direction 102c in the illustrated embodiment. The sidewalls 108 are offset from one another along the horizontal direction 102a such that the cargo floor 106 and sidewalls 108 define a cargo area.

An edge of the cargo floor 106 has a gate 110 secured thereto. The gate 110 may be implemented as the tailgate of a pickup truck, a front gate for accessing a frunk, or other type of gate of a vehicle. When closed, the gate 110 may latch to the sidewalls 108. A surface 110a of the gate 110 faces inwardly when the gate 110 is closed and cooperates with the cargo floor 106 and inner surfaces of the sidewalls 108 to define a cargo volume when the gate 110 is closed. The gate 110 may pivot open and closed with respect to the cargo floor 106, such as about an axis of rotation that is substantially (e.g., within 5 degrees of) parallel to the horizontal direction 102a. In some methods of use, the gate 110 is positioned such that the surface 110a of the gate 110 is substantially (e.g., within 5 degrees of) parallel to the cargo floor 106 and/or substantially (e.g., within 10 cm of) coplanar with the cargo floor 106. In other methods of use, the gate 110 is used partially open, such as with the surface 110a at an angle of between 0 and 50 degrees relative to the cargo floor 106 in a plane parallel to the direction of travel and the direction of gravity when the vehicle 104 is on a flat surface.

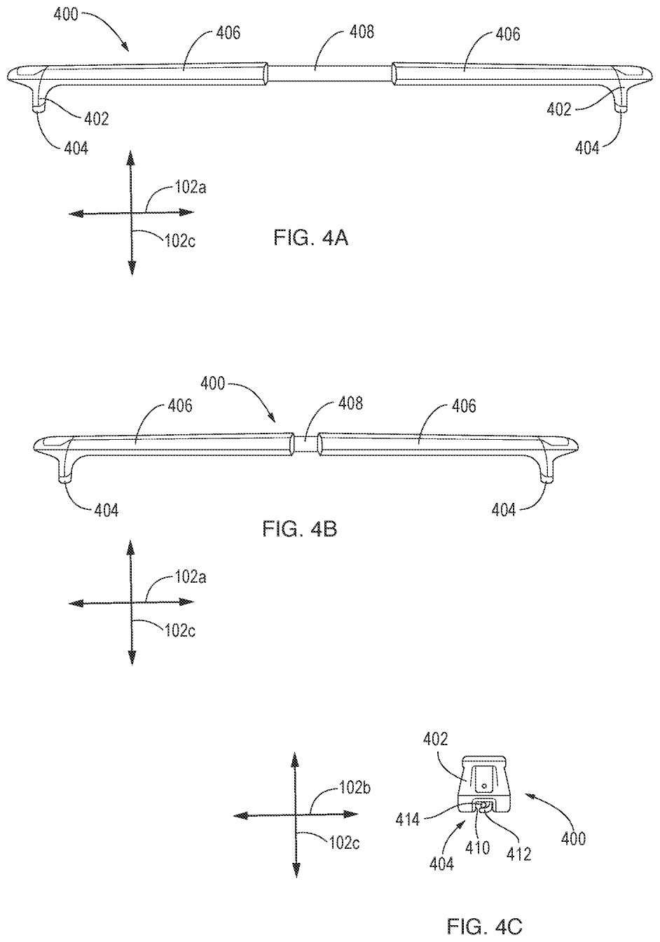

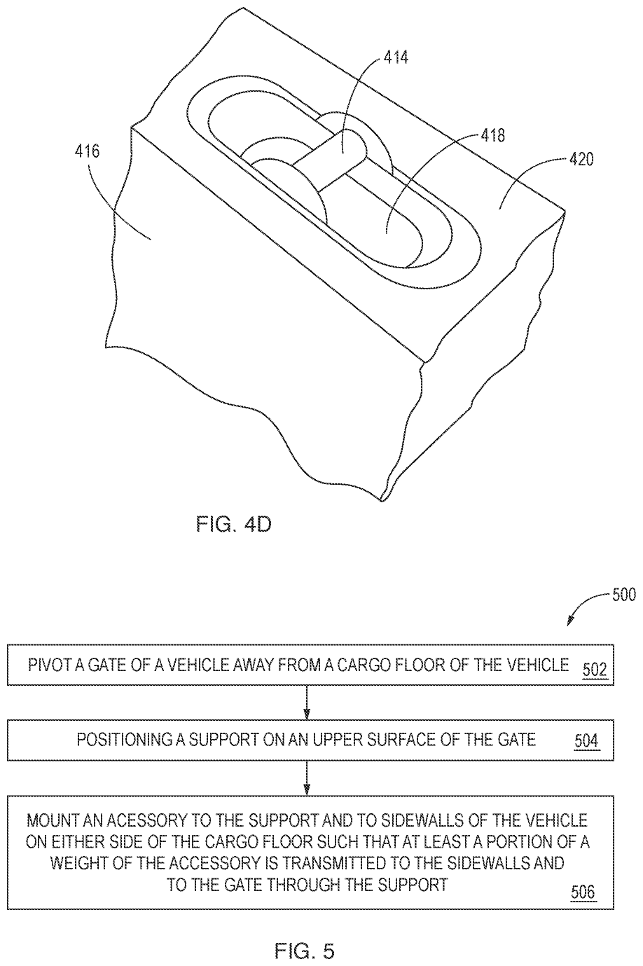

An accessory 112 may mount to the vehicle 104 over the cargo floor 106. The accessory 112 may be embodied as a pop-up camper, tent, storage container, or other type of accessory. The accessory 112 may be mounted to the sidewalls 108 or to the cargo floor 106 itself, such as to a frame mounted to the cargo floor 106. In the illustrated embodiment, one, two, or more crossbars 114a may be mounted to both sidewalls 108, and the accessory 112 may be mounted to each crossbar 114a. The one or more crossbars 114a and the structures for mounting the one or more crossbars 114a to the sidewalls 108 may be implemented according to any approach known in the art. Likewise, the structures by which the accessory 112 secures to the one or more crossbars 114a may be implemented according to any approach known in the art. The sidewalls 108 may define pockets including anchors to which the one or more crossbars 114a secure. An example embodiment of a crossbar 114a and a pocket for mounting a crossbar 114a are described below with respect to FIGS. 4A, 4B, and 5.

A portion of the accessory 112 may extend outwardly from the envelope of the vehicle 104. The envelope of the vehicle 104 may be defined as completely containing the vehicle 104 along the direction of travel when the gate 110 is completely closed, e.g., latched to the sidewalls 108 in the case of a tailgate for a pickup truck.

The accessory mount 100a, 100b, 100c may also be at least partially located outside the envelope of the vehicle 104 during use and spans between the accessory 112 and the gate 110 such that the accessory mount 100a. 100b, 100c transfers at least a portion of the weight of the accessory 112 to the gate 110. Although the accessory mount 100a, 100b, 100c is advantageously used with the gate 110 at least partially open, the accessory mount 100a. 100b, 100c may also be used with the gate 110 completely closed, such as by mounting to an upper edge of the gate 110 or by mounting to the surface 110a and extending upwardly therefrom.

The accessory mount 100a. 100b, 100c may mount directly to the accessory 112. Alternatively, a crossbar 114b may mount to the accessory mount 100a, 100b,100c with the accessory 112 being mounted to the crossbar 114b. The crossbar 114b and the structures by which the crossbar 114b mounts to the accessory mount 100a, 100b, 100c may be the same as or different from the one or more crossbars 114a and the structures by which the one or more crossbars 114a mount to the sidewalls 108. When mounted to the crossbars 114a, 114b, the top of the accessory 112 may be at or below the roof 104b of the vehicle 104 along the direction of gravity when the vehicle 104 is on a flat surface.

Referring specifically to FIG. 1A, the accessory mount 100a may include one or more bases 120, such as the illustrated two bases 120, each configured to contact the surface 110a of the gate 110. Each base 120 may include one or both of (a) a pad made of a resilient polymer, such as rubber, that is interposed between the accessory mount 100a and the surface 110a to reduce damage to the surface 110a and (b) one or more openings 122 receiving fasteners 124 for securing the base 120 to the surface 110a. In some embodiments, the accessory 112 is secured to the vehicle 104 by securing the accessory 112 to the one or more crossbars 114a, such that the accessory mount 100a is used only to transfer weight to the gate 110. In such embodiments, the base 120 may simply rest on the surface 110a without fastening thereto, such that a pad may be used to reduce damage to the surface 110a. In such embodiments, the openings 122 and fasteners 124 may be omitted.

In other embodiments, the accessory mount 100a is used to secure the accessory 112 to the vehicle 104 such that the openings 122 and fasteners 124 are used and an intervening pad may be omitted or retained. Where the accessory mount 100a secures to the gate 110, other fastening approaches may be used, such as mounting brackets, quick release fasteners, or other types of fasteners. For example, the approach described below with respect to FIGS. 4A to 4D for securing a crossbar 114a, 114b to the sidewalls 108 or accessory mount 100a may likewise be used to secure the bases 120 to the gate 110.

The accessory mount 100a include supports 126 secured to each base and extending outwardly from each base 120, such as substantially parallel to the vertical direction 102c. In the illustrated embodiment, the base 120 may extend outwardly from the support 126 to which it secures in the horizontal and longitudinal directions 102a, 102b. In other embodiments, the base 120 may be a lower surface extending across the support 126 that does not extend outwardly therefrom in the horizontal and longitudinal directions 102a, 102b. Each support 126 may be implemented as a column that is either straight sided, e.g., having sides parallel to the vertical direction 102c, or may have slanted or tapered sides, such as the illustrated shape in which the sides of the support 126 flair outwardly with distance along the vertical direction 102c from the base 120. The supports 126 may be offset from one another during use along the horizontal direction 102a, such as by a distance that is between 80 and 95 percent of a width of the gate 110 in the horizontal direction 102a, with the distance being measured from the centers of the supports 126.

The accessory mount 100a may include braces 128 that mount the accessory mount 100a to one or both of the cargo floor 106 and sidewalls 108. For example, the braces 128 may extend rearwardly along the longitudinal direction 102b to mounting points 130 on the sidewalls 108. The illustrated braces 128 each include two members 128a, 128b that extend from mounting points on one of the supports 126 that are offset from one another in the vertical direction 120c and are angled inwardly toward one another such that the members 128a, 128b converge on the mounting point 130. Other configurations for each brace 128 are possible, such as single member extending from each support 126 to the mounting point 130 on the sidewall 108 to which the brace 128 secures.

The mounting points 130 may be implemented as threaded openings mounted on the sidewalls 108 engaging fasteners passing through the braces 128. Other fastening approaches may be used to secure the braces 128 to the sidewalls 108, such as mounting brackets, quick release fasteners, or other types of fasteners.

The base 120, supports 126, and braces 128 may be made of metal (e.g., aluminum or steel) and welded together or fastened together by bolts or other fasteners. The base 120, supports 126, and braces 128 may be made of plastic (e.g., polyvinyl chloride (PVC), acrylonitrile butadiene styrene (ABS), polypropylene, acrylic, polyethylene, polystyrene, or the like) and formed by co-molding or secured to one another by plastic welding, adhesive, bolts, or other fasteners. The base 120, supports 126, and braces 128 may be made of a composite material, such as a carbon fiber, fiberglass, Kevlar, or other composite material as a single monolithic member or as separate members secured to one another by adhesive, bolts, or other fasteners. The base 120, supports 126, and braces 128 may be made of the same material or different materials among those listed above.

Each support 126 may include a mounting structure 132 configured to mount directly to the accessory 112 or to mount to the crossbar 114b. For example, the mounting structure 132 may be implemented according to the approach described below with respect to FIGS. 4A, 4B, and 4D. In some embodiments, the extent of the crossbar 114b in the horizontal direction 102a during use is less than the extent of the crossbars 114a in the horizontal direction 102a. For example, the crossbars 114a, 114b may be crossbars having adjustable widths as described below with respect to FIGS. 4A and 4B. In some embodiments, the separation of the supports 126 in the horizontal direction 102a (e.g., distance between outermost surfaces along the horizontal direction 102a) may be less than the separation of the sidewalls 108 due to the size of the gate 110, such that the crossbar 114b is shorter in the horizontal direction 102a than the crossbars 114a during use.

Referring specifically to FIG. 1B, the accessory mount 100b may include one or more bases 140, such as the illustrated two bases 140, each configured to contact the surface 110a of the gate 110. Each base 140 may include a pad made of a resilient polymer, such as rubber, that is interposed between the accessory mount 100b and the surface 110a to reduce damage to the surface 110a. The bases 140 may be elongated relative to the bases 120, such as having a length in the longitudinal direction 102b of between 50 and 100 percent, or between 75 and 100 percent, of the extent of the gate 110 outwardly from an axis of rotation thereof as measured along the direction of travel of the vehicle when the gate 110 is completely open.

A support 142 is mounted to each base 140 by means of welds, bolts, adhesive, or other fastener. Each support 142 extends upwardly from the base 140 to which it is secured in the vertical direction 102c. In the illustrated embodiment, each support 142 decreases in length along the longitudinal direction 102b with distance in the vertical direction 102c from the base 140 to which the support 142 is mounted. In the illustrated embodiment, each support 142 has a substantially uninform width in the horizontal direction 102a (e.g., all points thereon within 15 percent of the maximum width of the support 142 in the horizontal direction 102a, with the exception of any through holes). In the illustrated embodiment, the base 140 secured to each support 142 extends outwardly from at least one side of the support 142 along the horizontal direction 102a. For example, for the illustrated two supports 142, the bases 140 extend inwardly toward one another and away from the supports 142. The base 140 may therefore considered to be an inwardly extending flange formed on the support 142 to which the base 140 is secured. The outward extension of the base 140 from the support 142 to which the base 140 is mounted may resist tipping of the support 142 in a plane parallel to the horizontal and vertical directions 102a, 102c.

A crosspiece 144 spans across the supports 142 in the horizontal direction 102a and secures to each support 142. The bases 140, supports 142, and crosspiece 144 may be made of any of the materials described above with respect to the accessory mount 100a. The crosspiece 144 may maintain the supports 142 offset from one another during use along the horizontal direction 102a, such as by a distance that is between 80 and 95 percent of a width of the gate 110 in the horizontal direction 102a, with the distance being measured from the centers of the supports 142.

The crosspiece 144 may rigidly fasten to each support 142 by means of welds, bolts, adhesive, or other fastener. The crosspiece 144 may preferably be located toward the top of the supports 142 such that the cargo floor 106 is accessible with the accessory mount 100b in use. For example, the upper surface of the crosspiece 144 and upper surfaces of the supports 142 along the vertical direction may be flush with one another or substantially (e.g., within 5 cm of) flush with one another along the vertical direction 102c. In some embodiments, the crosspiece 144 and supports 126 are positioned such that at least 50 percent, at least 75 percent, or at least 85 percent of an area extending between the accessory 112, cargo floor 106, and sidewalls 108 in a plane parallel to the horizontal and vertical directions 102a, 102c is unobstructed by the supports 142 and crosspiece 144.

The crosspiece 144 may serve one or more functions, such as to resist tipping of the supports 142, such as tipping in a plane parallel to the horizontal and vertical directions 102a, 102c. The crossbar 114b or the accessory 112 itself may mount to the accessory mount 100b by means of mounting structures 146. The mounting structures 146 may be implemented according to the approach described below with respect to FIGS. 4A, 4B, and 4D. The mounting structures 146 may mount to one or both of the supports 142 and the crosspiece 144.

Referring specifically to FIG. 1C, the accessory mount 100c may include one or more bases 150 configured to contact the surface 110a of the gate 110. Each base 150 may include a pad made of a resilient polymer, such as rubber, that is interposed between the accessory mount 100c and the surface 110a to reduce damage to the surface 110a. One or more supports 152 are mounted to each base 150 by means of welds, bolts, adhesive, or other fastener. Each support 152 extends upwardly from the base 150 to which it is secured in the vertical direction 102c.

The supports 152 may be joined together by multiple crosspieces 154a, 154b, 154c. The crosspieces 154a, 154b, 154c maintain the supports 152 offset from one another during use along the horizontal direction 102a, such as by a distance that is between 80 and 95 percent of a width of the gate 110 in the horizontal direction 102a, with the distance being measured from the centers of the supports 142. The crosspiece 154a, 154b, 154c may serve one or more functions, such as to resist tipping of the supports 152, such as tipping in a plane parallel to the horizontal and vertical directions 102a, 102c. The crosspieces 154a, 154b, 154c may act as a gate to retain items within the cargo area of the vehicle 104.

The crosspieces 154a, 154b, 154c may include an upper crosspiece 154a, a lower crosspiece 154b, and a diagonal crosspiece 154c. The upper and lower crosspieces 154a, 154b are offset from one another along the vertical direction 102c, such as by an amount equal to between 50 and 100 percent of the height of the supports 152. The diagonal crosspiece 154c extends between the supports 152 at an angle of between 45 and 10 degrees.

One or both of the supports 152 and the upper crosspiece 154a include mounting structures 156 configure to mount to the crossbar 114b or to the accessory 112 itself. The mounting structures 156 may be implemented according to the approach described below with respect to FIGS. 4A, 4B, and 4D. The bases 140, supports 142, and crosspiece 144 may be made of any of the materials described herein with respect to the accessory mount 100a.

The accessory mount 100c may additionally include braces 158 secured to the supports 152 and including mounting points for mounting on the cargo floor 106 or sidewalls 108 of the vehicle 104. The braces 158 may have some or all of the attributes of the braces 128 and mounting points 130 as described above.

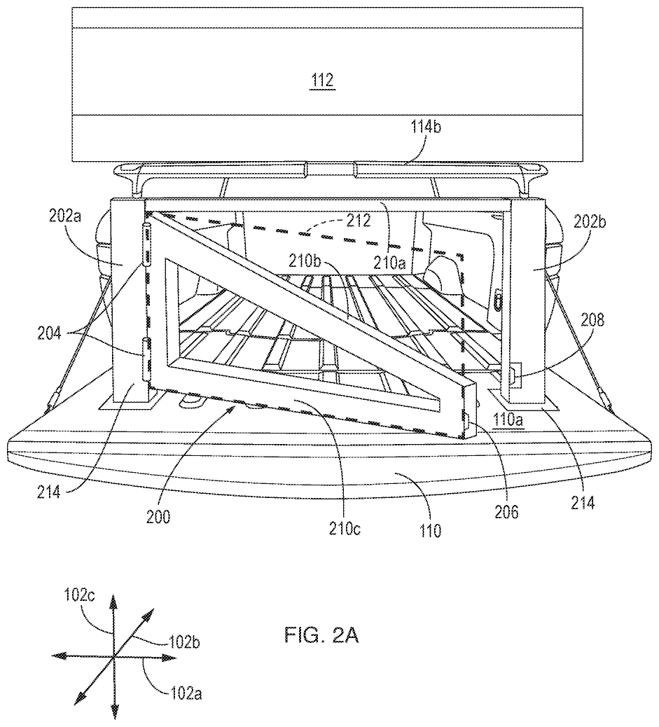

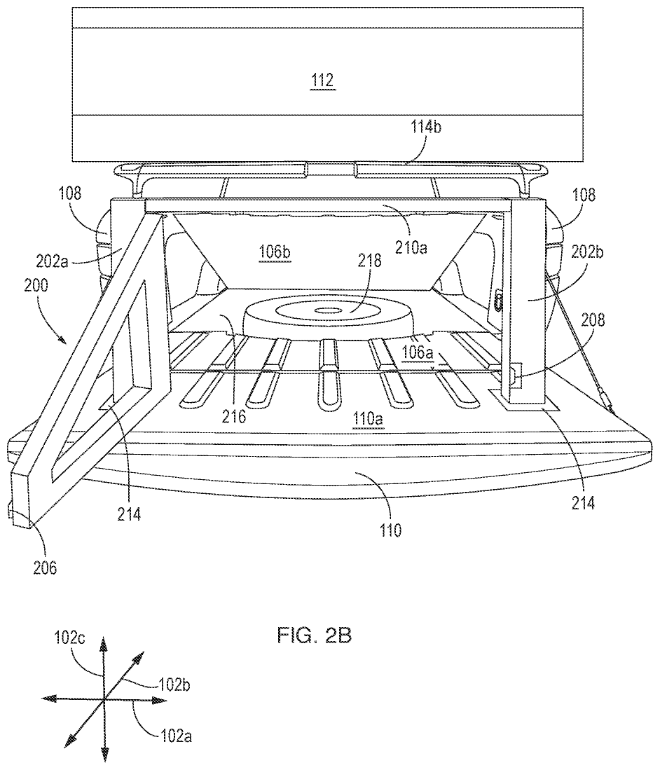

Referring to FIG. 2A, an accessory mount 100a, 100b, 100c according to any of the foregoing embodiments may include a door 200. The door 200 may be pivotally mounted by hinges 204 to a support 202a, such as a support 126, 142, 162 according to any of the accessory mounts 100a, 100b, 100c described herein. The door 200 may have a striker 206 mounted thereto that selectively engages a latch 208 mounted to another support 202a, such as a second support 126, 142, 162 according to any of the foregoing embodiments.

A crosspiece 210a may secure to each of the supports 202a. 202b. The crosspiece 210a may have some or all of the attributes of the crosspiece 144 of the accessory mount 100a or the crosspiece 154a of the accessory mount 100c. The crosspiece 210a may advantageously maintain constant the separation between the supports 202a, 202b to facilitate consistent latching and unlatching of the striker 206 and latch 208. The latch 208 may be lockable by a key or electronic actuator to prevent unauthorized opening of the door 200. The mounting locations of the striker 206 and latch 208 may be reversed, with the striker 206 mounted to the support 202b and the latch 208 mounted to the door 200.

The door 200 may function primarily to contain items within the cargo area of the vehicle 104. However, the door 200 may also provide structural rigidity. For example, door 200 may include crosspieces 210b, 210c having some or all of the attributes and providing some or all of the functionality of the crosspieces 154b, 154c of the accessory mount 100c. Alternatively, for the accessory mount 100c, a statically mounted lower crosspiece 154c may be retained as described above with the function of the diagonal crosspiece 154b being provided by the door 200.

The door 200 may include a panel 212 fastened to the crosspieces 210b, 210c or other frame member or mounted by hinges 204 to the support 202a without an additional frame member. The panel 212 may occupy substantially all of the area between the crosspiece 210a, supports 202a, 202b, and the surface 110a in a plane parallel to the horizontal and vertical directions 102a, 102c, such as from 50 to 100 percent, from 80 to 100 percent, or from 90 to 100 percent of the area. The supports 126, 142, 162 may be configured to provide clearance for the panel 212 while resting on the surface 110a of the gate 110.

Referring to FIG. 2B, the cargo floor 106 may function in combination with one or more panels 106a, 106b. Panel 106a may be pivotally secured to the gate 110 or to the cargo floor 106 and rotated to cover a gap that would otherwise be present between the cargo floor 106 and the gate 110 when the gate 110 is open and pivot to be lie flat against one of the cargo floor 106 or gate 110 when the gate 110 is closed. The bases 214 to which the supports 202a, 202b are mounted, such as bases 120, 140, 150 according to any of the accessory mounts 100a. 100b, 100c described above, are sized and configured to rest on the surface 110a without contacting the panel 106a or points on the surface 110a within a range of motion of the panel 106a such that the bases 214 do not interfere with functioning of the panel 106a.

The panel 106b may cover a compartment 216. The panel 106b may be pivotally attached at a forward or lateral edge to the cargo floor 106. The compartment 216 may contain a spare tire 218 or provide additional storage for other items. The crosspiece 210 advantageously enables a user to open the panel 106b sufficiently to access the compartment 216 and extract the spare tire 218 or other items. The accessory 112 may likewise be mounted at a sufficient height above the cargo floor to facilitate access to the compartment 216 and extraction of the spare tire 218.

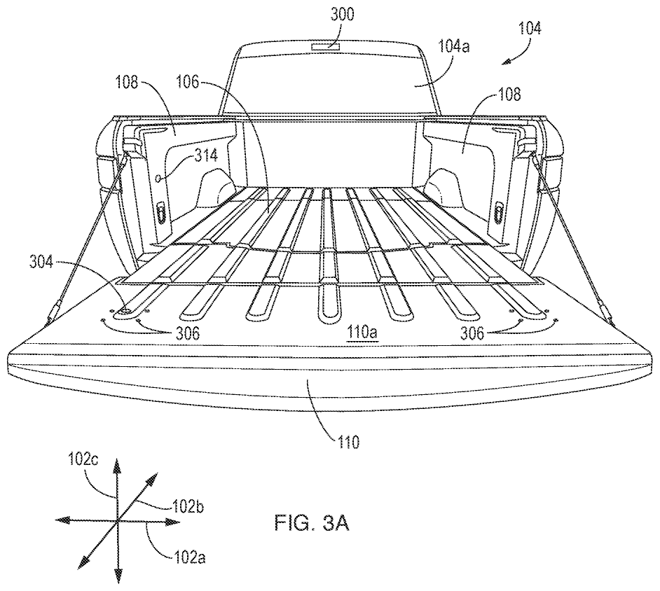

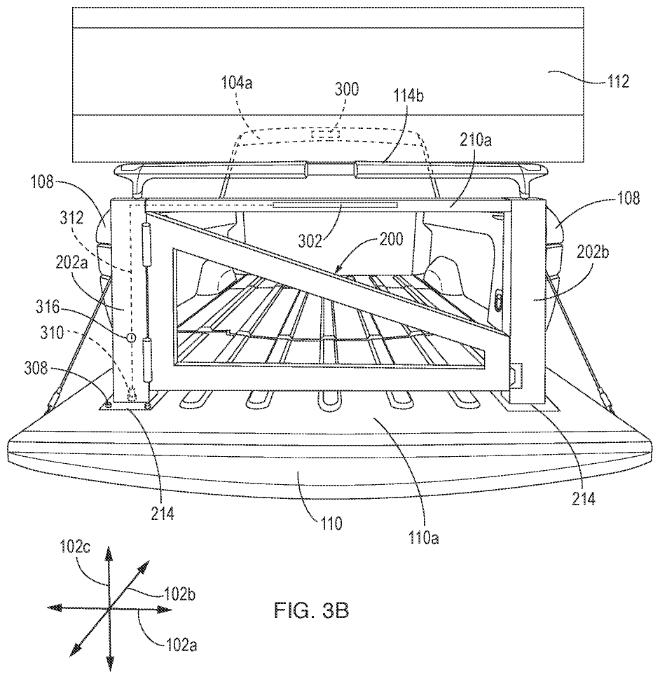

Referring to FIGS. 3A and 3B, the accessory 112 may obstruct a center brake light 300 of the vehicle 104 mounted to the rear of a cab 104a of the vehicle 104 embodied as a pickup truck. An accessory mount 100b, 100c as described above may advantageously incorporate a brake light 302 to provide brake signaling for the vehicle 104 in place of a brake light 300 obscured by the accessory 112.

For example, the gate 110 may define a port 304. The port 304 may be in wired or wireless communication with a controller of the vehicle 104 (e.g., via one or more electrical connectors that connect the port 304 to the controller), such as an electronic control unit (ECU) or other type of controller. The controller may supply power to the port 304 or cause another power source to supply power to the port 304 (e.g., in response to activation of the brakes of the vehicle 104). The port 304 may be located adjacent (e.g., within 10 cm) of openings 306 for receiving fasteners 308 for securing one or more bases 214 to the gate 110, such as the fasteners 124 described above with respect to the accessory mount 100a. The openings 306 may be threaded and may be formed in or rigidly secured to structural members forming the gate 110.

A support 202a or 202b (the support 202a in the illustrated embodiment) may include a connector 310 configured to dock with the port 304. The connector 310 may be electrically coupled by two or more wires 312 to the brake light 302 mounted to the upper crosspiece 210a. The support 202a and upper crosspiece 210b may be hollow such that the wires 312 pass through the support 202a and crosspiece 210b to connect to the brake light 302. The controller of the vehicle 104 may activate the brake light 302 in response to activation of the brakes (which may include regenerative braking) of the vehicle 104 along with other brake lights mounted to the sidewalls 108 of the vehicle 104. In some embodiments, the controller senses the connection of the connector 310 to the port 304 and activates the brake light 302 in response to braking when the connector 310 is determined to be connected to the port 304.

Note that in some embodiments, a port 314 may be placed on the sidewall 108 or cargo floor 106 of the vehicle 104 and function in the same manner as the port 304. In such embodiments, the connector 310 and wires 312 may extend outwardly from the support 202a in the form of a flexible cable, and a user many engage the connector 310 with the port 314 manually as part of installing an accessory mount 100a, 100b, 100c according to any of the embodiments described herein.

In some embodiments, the port 304 may provide electrical connections to a power supply of the vehicle 104 providing power, such as 5V DC power, 12V DC power, 110V AC power, 220V AC power, etc. The wires 312 may therefore connect to a socket 316 secured to the support 202a, support 202b, crosspiece 210a, or elsewhere. The power supply of the vehicle 104 may be a battery and inverter of an internal combustion engine (ICE) vehicle or electric-only vehicle.

Referring to FIGS. 4A to 4C, a crossbar 114b, and possibly the one or more crossbars 114a, may be implemented as the illustrated crossbar 400. The crossbar 400 may include any of the embodiments disclosed in U.S. Pat. No. 11,027,661, which is hereby incorporated by reference in its entirety. The illustrated crossbar 400 is exemplary only. Any crossbar known in the art may be used to implement the crossbar 114b and one or more crossbars 114a.

The crossbar 400 includes two supports 402, each including an interface 404 for mounting to a vehicle. Each support 402 is mounted to an outer piece 406. An inner piece 408 is slidably received within each outer piece 406. The outer pieces 406 may be translated relative to one another with the inner piece 408 bridging a gap between the outer pieces 406. The outer pieces 406 may be locked in a given position relative to the inner piece 408 following translation. In this manner, the supports 402 may be mounted at a variety of widths. One or both of the outer pieces 406 and the inner piece 408 may include structures for mounting the accessory 112. The accessory 112 may mount by clamping to the exterior of the outer pieces 406 and/or inner piece 408. The outer piece 406 and/or inner piece 408 may define openings, channels, etc. for receiving mounting structures to secure the accessory 112 thereto.

Referring to FIG. 4D, while still referring to FIG. 4C, the interface 404 may be embodied as the latch device disclosed in U.S. patent application Ser. No. 17/130,202 (published as US 2022/0194301), which is hereby incorporated herein by reference in its entirety. The interface 404 may include a slot 410 formed in the support 402. A latch 412 is pivotable into the slot 410 and lockable in place in order to capture a striker bar 414 within the slot 410. The striker bar 414 may be mounted to a support 416, such as a support 126, 142, 152, 202 according to any of the embodiments disclosed herein. The support 416 may define a pocket 418 extending inwardly into the support 416, such as inwardly from a surface 420 of the support. The surface 420 may be parallel to the horizontal and longitudinal directions 102a, 102b or have some other orientation. The pocket 418 may extend into the surface 420 in the vertical direction 102c. The striker bar 414 may extend across the pocket 418 and be either positioned above the pocket 418 along the vertical direction 102c or be partially or completely positioned within the pocket 418. During use, the latch 412 may pass into the pocket 418 in order to extend around the striker bar 414 to secure the support 402 to the support 416. The illustrated pocket 418 and striker bar 414 may be used to implement the mounting structures 132, 146, 156 according to any of the foregoing embodiments. However, other mounting structures may also be used.

FIG. 5 illustrates a method 500 for using an accessory support, such as an accessory support 100a, 100b, 100c according to any of the foregoing embodiments. The method 500 includes pivoting, at block 502, a gate of a vehicle away from a cargo floor of the vehicle, such as pivoting the gate 110 away from the cargo floor 106 of the vehicle 104. The method 500 may include positioning, at block 504, a support on an upper surface of the gate, such as a support 126, 142, 152, 202a, 202b according to any of the embodiments disclosed herein. The method 500 may include mounting, at block 506, an accessory, such as the accessory 112, to the support and to sidewalls of the vehicle (e.g., sidewalls 108 of the vehicle 104) on either side of the cargo floor such that at least a portion of a weight of the accessory is transmitted to the sidewalls and to the gate through the support.

In some embodiments, the support includes a first support and the method further includes positioning a second support (e.g., a second support 126, 142, 152, 202a, 202b according to any of the embodiments disclosed herein) on the upper surface of the gate. The method may further include mounting the accessory to the second support such that a portion of the weight of the accessory is transmitted to the gate through the second support. In some embodiments a crosspiece (e.g., a crosspiece 144, 154a, 154b, 154c, 210a, 210b, 210c according to any of the foregoing embodiments) is secured to the first support and the second support to resist tipping of the first support and the second support.

In some embodiments, the method further includes fastening a first brace, such as a brace 128, 158 according to any of the foregoing embodiments, to at least one of the cargo floor and a first sidewall of the sidewalls, the first brace being secured to the first support. The method may further include fastening a second brace, such as another brace 128, 158, to at least one of the cargo floor and a second sidewall of the sidewalls, the second brace being secured to the second support.

In some embodiments, pivoting the gate away from the cargo floor further comprises pivoting a panel, such as a panel 106a, such that the panel is positioned over a gap between the cargo floor and the gate. The first support and the second support may be configured to provide clearance for the panel while resting on the upper surface of the gate.

In some embodiments, the method 400 includes mounting a first crossbar, such as a crossbar 114b, to the first support and the second support, the accessory being mounted to the first crossbar. The method may include mounting the accessory to one or more second crossbars, such as one or more crossbars 114a, mounted to the sidewalls.

The first support and the second support may be positioned on the upper surface of the gate such that a space between the accessory and the cargo floor is accessible between the first support and the second support.

In some embodiments, a support brake light, such as a brake light 302, is mounted to a crosspiece extending between the first support and the second support. In such embodiments, the method may further include electrically coupling an electrical connector (e.g., connector 310) mounted to at least one of the first support and the second support to a port, such as a port 304, mounted to the gate. The electrical connector may be electrically connected to the support brake light, and the port may be in communication with a controller of the vehicle. The controller of the vehicle may be configured to cause power to be supplied to the port in response to activation of brakes of the vehicle to provide brake signaling for the vehicle in place of a vehicle brake light, such as the brake light 300, obscured by the accessory.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

While the foregoing is directed to embodiments of the present disclosure, other and further embodiments may be devised without departing from the basic scope thereof, and the scope thereof is determined by the claims that follow.

What is claimed is:

1. An apparatus, comprising:
a support configured to interface with an inner surface of a gate of a vehicle, the support being further configured to support an accessory; and
a mounting structure mounted to the support and configured to mount to at least one of the accessory or a crossbar to which the accessory is mounted.

2. The apparatus of claim 1, further comprising a base secured to the support and configured to fasten to the gate.

3. The apparatus of claim 1, further comprising a brace defining a mounting point configured to mount to at least one of a cargo floor and a sidewall of the vehicle to resist tipping of the support.

4. The apparatus of claim 1, wherein the support comprises a first support and the mounting structure comprises a first mounting structure, the apparatus further comprising:
a second support configured to interface with the inner surface of the gate, the second support being further configured to support the accessory; and
a second mounting structure mounted to the second support and configured to mount to the at least one of the accessory or the crossbar to which the accessory is mounted.

5. The apparatus of claim 4, further comprising a crosspiece secured to the first support and the second support and configured to resist tipping of the first support and the second support.

6. The apparatus of claim 4, further comprising a door pivotally secured to the first support and configured to latch with respect to the second support, the door configured to substantially cover: (i) an area extending between the accessory and a cargo floor of the vehicle, and (ii) an area extending between the first support and the second support.

7. The apparatus of claim 1, wherein the mounting structure comprises a pocket defined by the support and configured to receive a crossbar mount secured to the crossbar.

8. The apparatus of claim 7, wherein the mounting structure further comprises a striker bar extending across the pocket and configured to engage a latch of the crossbar mount.

9. The apparatus of claim 1, further comprising:
an electrical component mounted to the support; and
an electrical connector coupled to the support and configured to electrically couple to a port on the gate when the support is resting on the inner surface of the gate.

10. The apparatus of claim 9, wherein the electrical component comprises a support brake light configured to provide brake signaling for the vehicle in place of a vehicle brake light obscured by the accessory.

11. The apparatus of claim 9, wherein the electrical component comprises an electrical socket.

12. A method comprising:
pivoting a gate of a vehicle away from a cargo floor of the vehicle;
positioning a support on an upper surface of the gate; and
mounting an accessory to the support and to sidewalls of the vehicle on either side of the cargo floor such that at least a portion of a weight of the accessory is transmitted to the sidewalls and to the gate through the support.

13. The method of claim 12, wherein the support comprises a first support, the method further comprising:
positioning a second support on the upper surface of the gate; and
mounting the accessory to the second support such that a portion of the weight of the accessory is transmitted to the gate through the second support.

14. The method of claim 13, wherein a crosspiece is secured to the first support and the second support to resist tipping of the first support and the second support.

15. The method of claim 13, further comprising:
fastening a first brace to at least one of the cargo floor and a first sidewall of the sidewalls, the first brace being secured to the first support; and
fastening a second brace to at least one of the cargo floor and a second sidewall of the sidewalls, the second brace being secured to the second support.

16. The method of claim 13, wherein pivoting the gate away from the cargo floor further comprises pivoting a panel such that the panel is positioned over a gap between the cargo floor and the gate, the first support and the second support configured to provide clearance for the panel while resting on the upper surface of the gate.

17. The method of claim 13, further comprising mounting a first crossbar to the first support and the second support, the accessory being mounted to the first crossbar.

18. The method of claim 17, further comprising mounting the accessory to one or more second crossbars mounted to the sidewalls.

19. The method of claim 13, wherein the first support and the second support are positioned on the upper surface of the gate such that a space between the accessory and the cargo floor is accessible between the first support and the second support.

20. The method of claim 13, further comprising a support brake light mounted to a crosspiece extending between the first support and the second support, the method further comprising:
electrically coupling an electrical connector mounted to at least one of the first support and the second support to a port mounted to the gate, the electrical connector being electrically connected to the support brake light and the port being in communication with a controller of the vehicle, the controller configured to cause power to be supplied to the port in response to activation of brakes of the vehicle to provide brake signaling for the vehicle in place of a vehicle brake light obscured by the accessory.
